(19) United States
(12) Patent Application Publication
(10) Pub. No.: US 2002/0191637 A1
(43) Pub. Date: Dec. 19, 2002

(54) Home appliance protocol upgrading system and method

(75) Inventors: Sang Kyun Lee, Kyungki-do (KR); Ki Tae Oh, Kyungki-do (KR); Yeon Kyung Lee, Kyungki-do (KR); Chang Ho Kim, Seoul (KR)

Correspondence Address: GREENBLUM & BERNSTEIN, P.L.C., 1941 ROLAND CLARKE PLACE, RESTON, VA, 20191, US

(73) Assignee: LG ELECTRONICS Inc., Seoul (KR)

(21) Appl. No.: 10/142,994

(22) Filed: May 13, 2002

(30) Foreign Application Priority Data
May 14, 2001 (JP) 2001-26100

(51) Int. Cl. H04L 12/28

(52) U.S. Cl. 370/465; 370/401

(57) ABSTRACT

A method is provided of upgrading the protocol of a networkable home appliance which is manufactured for use in a home network so as to have the ability to communicate through a gateway connected to an external communication network, and that has a flash memory for storing the protocol. The protocol stored in the flash memory is automatically upgraded with a new version thereof simply and conveniently without any waste of time or manpower. The protocol of the home appliance may be updated with the new version of the protocol in a service provision server which provides home appliance information. The version upgrade of an existing home appliance can be performed without a service visit or any manipulation by the user, thereby enabling data compatibility between the existing home appliance and a home appliance newly introduced to the market.

### BACKGROUND OF THE INVENTION

1. Field of the Invention

The present invention relates to a method of upgrading the protocol of a networkable home appliance, and in particular to a method of upgrading the protocol stored in flash memory with a new version of the protocol in a networkable home appliance having a flash memory for storing the protocol and for communicating through a gateway connected to an external communication network.

2. Description of the Related Art

Coinciding with the development of Internet networks, recently many home appliances have been constructed as multitask types having one or more functions in addition to their original functions. For example, some home appliance products may be equipped with local area network (LAN) cards or modems such that they are communicatably connected to communication networks. Such home appliance products may be upgraded to new versions through the transmission and reception of data over communication networks, or their operation may be controlled at any communication site remote from the installation site of the home appliance product.

Generally, in prior art systems, a communication device is provided in a home to transfer signals between home appliances, and to transmit and receive those signals via a communication cable. In this regard, for the purpose of gaining access to a particular home to control home appliances therein, an external remote system must be connected to a communication device in the particular home through a communication connection service provided by an Internet service provider (ISP), to transmit and receive data to and from the home appliances. In some cases, the program or protocol used in the home appliances may be upgraded by data transmission and reception procedures.

However, because home appliance products may be replaced at different times according to users' tastes, fashions, product lifetime, and other considerations, protocols for transmission and reception of signals, such as program data, may not be the same between home appliance products newly introduced to the market and older home appliance products in the home. For this reason, the transmission and reception of data between home appliance products may not be possible, even between products of the same manufacturer, thereby making it difficult to smoothly operate a home network.

In order to solve the above problems, old products must be replaced with newly introduced products, or the read only memory (ROM) or flash ROM of each home appliance having a protocol of the home appliance stored therein must be replaced directly with a new one. In this case, the user of each home appliance must deal with the inconvenience of checking the protocol whenever a new product comes on the market. In particular, the replacement of an old home appliance product with a new home appliance product increases the economic burden on the user.

### SUMMARY OF THE INVENTION

The present invention has been provided in view of the above problems, and it is an object of the present invention to provide a method of upgrading the protocol of a networkable home appliance manufactured for use in a home network so as to have the ability to communicate through a gateway connected to an external communication network, to automatically update the protocol stored in the flash memory with a new version of the protocol simply and conveniently without any waste of time or manpower.

According to the present invention, the above and other objects can be accomplished by a method of upgrading an existing protocol of at least one networkable home appliance, including updating the existing protocol of the home appliance with a new version of the protocol and storing the updated new version of the protocol in a service provision server, sending the new version of the protocol stored in the service provision server to a gateway connected to the home appliance, downloading the new version of the protocol from the service provision server to the gateway, and upgrading the existing protocol of the home appliance with the new version of the protocol downloaded to the gateway.

An aspect of the present invention includes a method of upgrading an existing protocol of at least one networkable home appliance, including updating the existing protocol of the home appliance with a new version of the protocol and storing the updated new version of the protocol in a service provision server, sending the new version of the protocol stored in the service provision server to a gateway connected to the home appliance, so as to download the new version of the protocol from the service provision server to the gateway, and upgrading the existing protocol of the home appliance with the new version of the protocol downloaded to the gateway.

According to a further aspect of the present invention, sending the new version of the protocol stored in the service provision server to a gateway connected to the home appliance includes determining whether a user of the home appliance desires to download the new version of the protocol from the service provision server to the gateway, and downloading the new version of the protocol from the service provision server to the gateway if it is determined that the user desires to download the new version of the protocol.

In a further aspect of the present invention, upgrading the existing protocol of the home appliance with the new version of the protocol downloaded to the gateway may include determining whether the existing protocol of the home appliance can be upgraded with the new version of the protocol and upgrading the existing protocol of the home appliance with the new version of the protocol if it is determined that the existing protocol of the home appliance can be upgraded with the new version of the protocol. Further, determining whether the existing protocol of the home appliance can be upgraded with the new version of the protocol may include comparing the size of an available area of a protocol storage memory of the home appliance with the data size of the new version of the protocol and, if the size of the available area of the protocol storage memory is greater than the data size of the new version of the protocol, determining that the existing protocol of the home appliance can be upgraded with the new version of the protocol.

In a further aspect of the present invention, upgrading the existing protocol of the home appliance with the new version of the protocol downloaded to the gateway may include allowing the home appliance to notify the gateway of an upgrade start address of a protocol storage memory thereof and writing the new version of the protocol into the protocol storage memory beginning with the upgrade start address. Further, the upgrade start address of the protocol storage memory may be spaced from a written address of the existing protocol with other addresses therebetween such that the existing protocol and the new version of the protocol are stored together in the protocol storage memory. Further, upgrading the existing protocol of the home appliance with the new version of the protocol if it is determined that the existing protocol of the home appliance can be upgraded with the new version of the protocol may include sequentially writing a version name of the new version of the protocol, random data and confirmation data into the protocol storage memory beginning with the upgrade start address, the random data being randomly extracted from the new version of the protocol, the confirmation data having the same size as that of the random data and writing the new version of the protocol into the protocol storage memory beginning with an address subsequent to a written address of the confirmation data. The method may also include comparing the random data with the confirmation data after storing the new version of the protocol, to determine whether the new version of the protocol has been properly written.

Another aspect of the present invention may include providing at least one networkable home appliance, the at least one networkable home appliance including a flash memory having an existing protocol stored therein, providing a gateway between the at least one networkable home appliance and a service provision server, providing connections between the at least one networkable home appliance and the gateway and between the gateway and the service provision server so that the networkable home appliance communicates with the service provision server through the gateway, providing an updated new version of the protocol and storing the updated new version of the protocol in the service provision server, sending the new version of the protocol stored in the service provision server through the connections to the gateway and downloading the new version of the protocol from the service provision server to the gateway, and upgrading the existing protocol of the home appliance with the new version of the protocol downloaded to the gateway.

According to a further aspect of the present invention, sending the new version of the protocol stored in the service provision server through the connections to the gateway connected to the home appliance may include determining whether a user of the home appliance desires to download the new version of the protocol from the service provision server to the gateway, and downloading the new version of the protocol from the service provision server to the gateway if it is determined that the user desires to download the new version of the protocol.

In a further aspect of the present invention, to upgrade the existing protocol of the home appliance with the new version of the protocol downloaded to the gateway, the home appliance notifies the gateway through the connections of an upgrade start address of a protocol storage memory thereof, and the gateway writes the new version of the protocol into the protocol storage memory beginning with the upgrade start address.

According to another aspect of the present invention, to upgrade the existing protocol of the home appliance with the new version of the protocol if it is determined that the existing protocol of the home appliance can be upgraded with the new version of the protocol, the gateway sequentially writes a version name of the new version of the protocol, random data and confirmation data into the protocol storage memory beginning with the upgrade start address, the random data being randomly extracted from the new version of the protocol, the confirmation data having the same size as that of the random data, and the gateway writes the new version of the protocol into the protocol storage memory beginning with an address subsequent to a written address of the confirmation data.

### BRIEF DESCRIPTION OF THE DRAWINGS

The above and other objects, features and other advantages of the present invention will be made apparent from the following detailed description of the preferred embodiments, given as non-limiting examples, with reference to the accompanying drawings in which:

FIG. 1 is a block diagram showing the construction of a networkable home appliance system, according to an aspect of the present invention;

FIGS. 2a and 2b are flow charts illustrating a method of upgrading the protocol of a networkable home appliance in the system of FIG. 1;

FIG. 3 is a schematic view showing a data arrangement of a flash memory installed in a networkable home appliance in the system of FIG. 1; and

FIG. 4 is a flow chart illustrating a procedure of processing communication data in a networkable home appliance in the system of FIG. 1.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, and the description is taken with the drawings making apparent to those skilled in the art how the forms of the present invention may be embodied in practice.

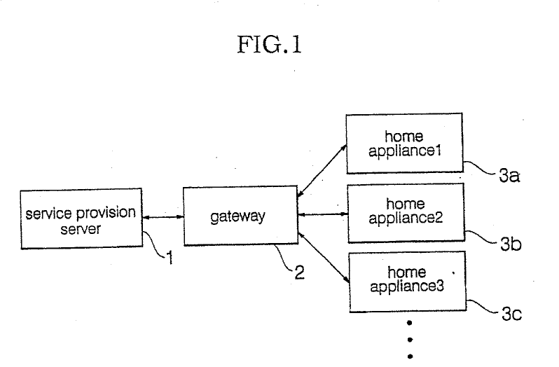

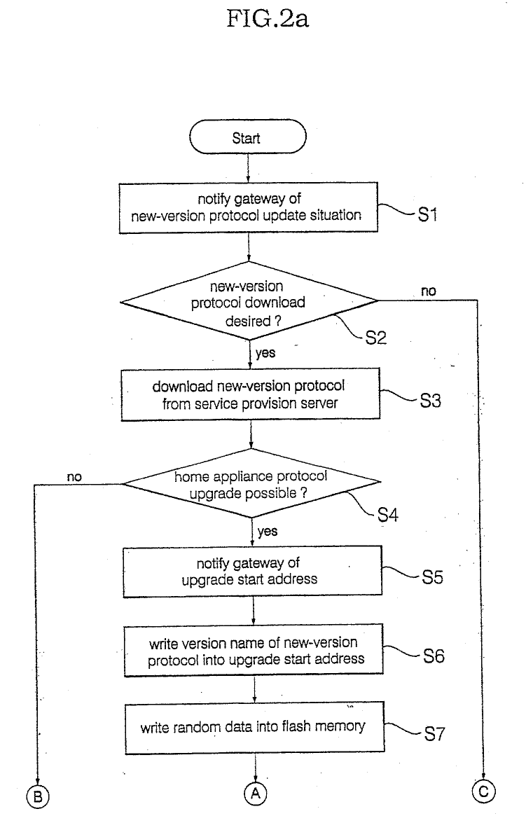

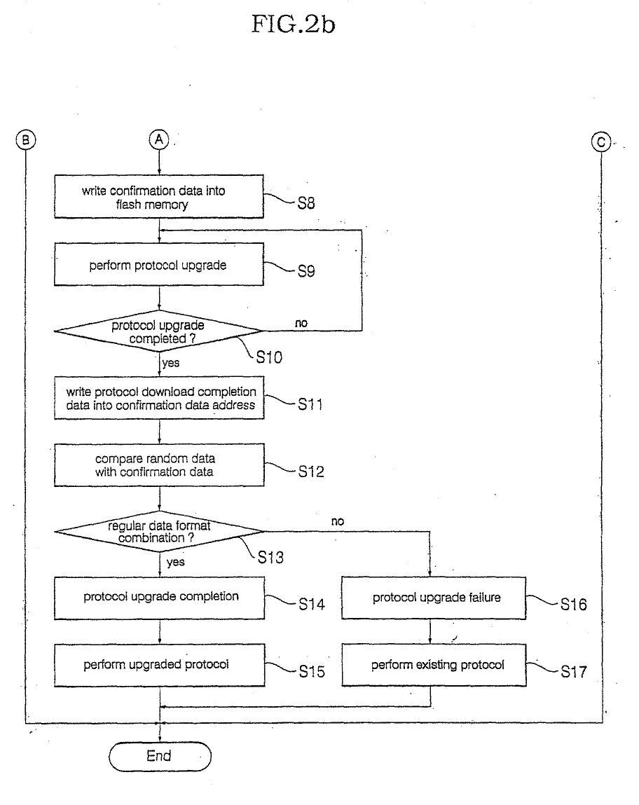

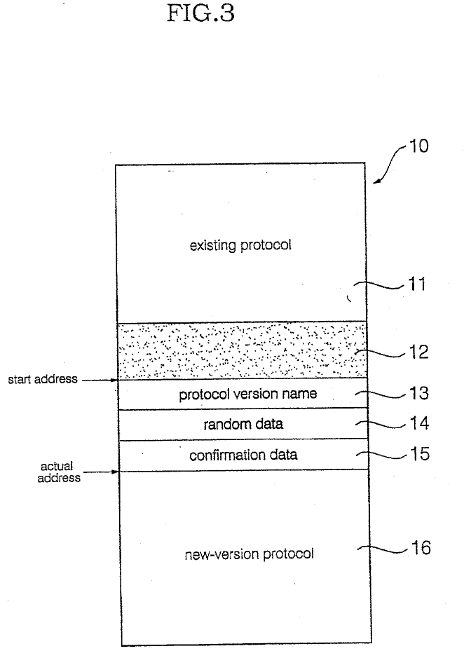

FIG. 1 is a block diagram showing the construction of a networkable home appliance system to which the present invention may be applied. FIGS. 2a and 2b are flow charts illustrating a method for upgrading the protocol of a networkable home appliance in the system of FIG. 1 and according to an aspect of the present invention. FIG. 3 is a schematic view showing a data arrangement of a flash memory installed in a networkable home appliance in the system of FIG. 1.

In a preferred embodiment of the present invention, the protocol or operating program of a networkable home appliance may be stored and upgraded in flash memory. Alternatively, in another embodiment of the present invention, the protocol or operating program may be stored and upgraded in any other suitable memory known to those skilled in the art, provided that such other suitable memory is appropriate to the objectives and operation of the present invention.

A detailed description of an embodiment of the networkable home appliance protocol upgrading method according to the present invention is discussed below, with reference to FIGS. 1, 2a, 2b and 3. Initially, in step S1, if an existing protocol 11 stored in a service provision server 1 is updated with a new version of the protocol 16, then the service provision server 1 notifies a gateway 2 connected to networkable home appliances 3a, 3b, and 3c of the new version of the protocol 16. The service provision server 1 will notify gateways installed in each applicable home. In the present embodiment, the service provision server 1 may store any suitable information such as, for example, product information; product Internet protocol (IP) variation information; or upgraded data relating to each product, appliance, or protocol; to remotely control the networkable home appliances 3a, 3b, and 3c.

Upon receiving the protocol update notification from the service provision server 1 in step S1, the gateway 2 determines in the second step S2 whether a user desires to download the new version of the protocol 16 from the service provision server 1. If it is determined in the second step S2 that the user does not desire to download the new version of the protocol 16, then the existing protocol 11 continues without downloading the new version of the protocol 16.

On the other hand, in the case where it is determined in the second step S2 that the user desires to download the new version of the protocol 16, the gateway 2 downloads the new version of the protocol 16 from the service provision server 1 in the third step S3.

After downloading the new version of the protocol 16 in the third step S3, the gateway 2 instructs each of the networkable home appliances 3a, 3b, and 3c in the home to determine whether it can upgrade the existing protocol 11 with the new version of the protocol 16, in the fourth step S4.

In the present embodiment, whether the protocol upgrade is possible can be determined on the basis of a comparison between the size of the available area of the flash memory 10 contained in each of the home appliances 3a, 3b and 3c, and the size of the new version of the protocol 16. If the available area of the flash memory 10 is greater in size than that required by the new version of the protocol 16, then the protocol upgrade is determined to be possible.

The flash memory 10 stores both the existing protocol 11 for networking of the home appliances 3a, 3b, and 3c and the new version of the protocol 16, between which is defined a shared area 12.

In the case where the protocol upgrade is determined to be possible in the fourth step S4, each of the home appliances 3a, 3b, and 3c notifies the gateway 2 of an upgrade start address of the flash memory 10 in the fifth step S5. Then the gateway 2 sends a packet containing the protocol version name 13 of the new version of the protocol 16 to each home appliance 3a, 3b, and 3c in the sixth step S6, to instruct the gateway 2 to write the version name 13 into the upgrade start address of which the gateway 2 was notified in the fifth step S5.

After writing the protocol version name 13 in the sixth step S6, the gateway 2 writes random data 14 into the flash memory 10 in the seventh step S7. Then, the gateway 2 writes confirmation data 15 having the same size as that of the random data 14 into the flash memory 10 in the eighth step S 8.

Note that the sixth through eighth steps S6 to S8 are steps initially performed by the gateway 2 for the upgrade of the existing protocol 11 in the flash memory 10 of each of the home appliances 3a, 3b and 3c with the new version of the protocol 16. That is, before downloading the new version of the protocol 16 from the gateway 2, each home appliance 3a, 3b, and 3c downloads the protocol version name 13, the random data 14 for determination whether the new version of the protocol 16 has been correctly downloaded, and the confirmation data 15 having the same size as that of the random data 14. These steps enable the protocol upgrade to be performed smoothly.

In the ninth step S9, the protocol upgrade is performed by downloading the new version of the protocol 16 from the gateway 2 and then writing the new version of the protocol 16 into the flash memory 10 beginning with an address subsequent to the address where the confirmation data 15 is written in the eighth step S8. In the tenth step S10, a determination is made as to whether the protocol upgrade has been completed.

If the protocol upgrade is determined not to have been completed in the tenth step S10, the method returns to the ninth step S9 to continue downloading the new version of the protocol 16. Alternatively, in the case where the protocol upgrade is determined to have been completed in the tenth step S 10, the method proceeds to the eleventh step S11 to update the confirmation data 15 written in the eighth step S8 by writing data indicative of the completion of the protocol download into the address of the confirmation data 15.

In the twelfth step S12, whether the new version of the protocol 16 has been normally and properly downloaded and the protocol upgrade has been thus normally and properly performed in the ninth step is determined by comparing the confirmation data 15 updated in the eleventh step S11 with the random data 14 written in the seventh step S7. In the thirteenth step S13, a determination is made as to whether the comparison in the twelfth step S12 exhibits a regular data format combination.

In the present embodiment, in the normal state, the random data 14 and the confirmation data 15 are the same or are regularly combined to have their formats shifted with respect to each other. In this regard, whether the upgrade of the existing protocol 11 with the new version of the protocol 16 has been normally and properly performed can be determined from the comparison between the random data 14 and the confirmation data 15.

Where the comparison is determined to exhibit the regular data format combination in the thirteenth step SI 3, the protocol upgrade is regarded as having been correctly completed in the fourteenth step S14, and data is processed among the home appliances 3a, 3b and 3c according to the upgraded new version of the protocol 16 in the fifteenth step S15.

However, in the case where the comparison does not exhibit the regular data format combination in the thirteenth step S13, the protocol upgrade is regarded as being stopped halfway subject to error occurrence, or not having been correctly completed, in the sixteenth step S16. In this case, data will be processed among the home appliances 3a, 3b, and 3c according to the existing protocol 11 in the seventeenth step S17.

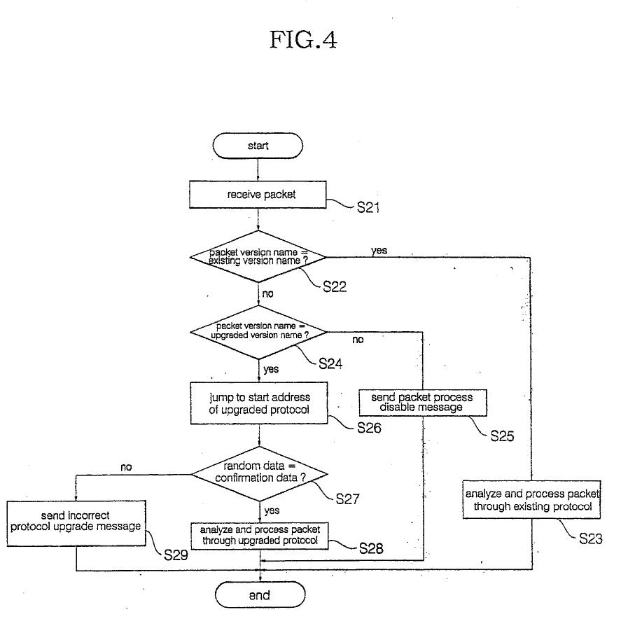

FIG. 4 is a flow chart illustrating a procedure of processing communication data in each home appliance 3a, 3b, and 3c after the protocol upgrade is performed. First, upon receiving a command packet sent from the gateway 2 in the first step S21, each of the home appliances 3a, 3b, and 3c analyzes a header of the received packet to determine whether a version name of the received packet is the same as an existing version name in the second step S22.

In the case where it is determined in the second step S22 that the version name of the received packet is the same as the existing version name, each home appliance analyzes and processes the received packet through the existing protocol 11 in the third step S23.

On the other hand, if the version name of the received packet is not the same as the existing version name in the second step S22, each home appliance 3a, 3b, and 3c compares the version name of the received packet with the version name 13 of the upgraded protocol stored in the flash memory 10 thereof to determine whether they are the same in the fourth step S24.

Upon determining in the fourth step S24 that the two version names are not the same, each home appliance 3a, 3b, and 3c recognizes that it cannot process the received packet, and then sends a packet process disable message to the gateway 2 in the fifth step S25.

On the other hand, in the case where the two version names are determined to be the same in the fourth step S24, each home appliance 3a, 3b, and 3c recognizes that the received packet must be processed according to the upgraded protocol 16. As a result, each home appliance 3a, 3b, and 3c moves to a start address of the new version of the protocol 16 in the sixth step S26, and then determines in the seventh step S27 whether the random data 14 and the confirmation data 15 are the same, so as to determine whether the protocol upgrade has been correctly performed.

Where the random data 14 and the confirmation data 15 are determined to be the same in the seventh step S27, each home appliance 3a, 3b, and 3c recognizes that the new version of the protocol 16 has been stored therein with no error and the existing protocol 11 has been upgraded with the new version of the protocol 16. Thus, each home appliance 3a, 3b, and 3c analyzes and processes the packet received in the first step S21 through the upgraded new version of the protocol 16 in the eighth step S28.

However, where the random data 14 and the confirmation data 15 are determined not to be the same in the seventh step S27, each home appliance 3a, 3b, and 3c sends an incorrect protocol upgrade message to the gateway 2 in the ninth step S29.

As is apparent from the above description, the present invention provides a method of upgrading the protocol of a networkable home appliance which is manufactured for use in a home network so as to be communicatable through a gateway connected to an external communication network and has a flash memory for storing the protocol, wherein the protocol stored in the flash memory is automatically upgraded with a new version thereof simply and conveniently without waste of time and manpower. According to this invention, the version upgrade of an existing home appliance can be performed without a home service visit or any manipulation by the user at all. Therefore, the present invention has the effect of establishing data compatibility between an existing home appliance and a home appliance newly introduced or released to the market.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, XML, HTTP) represent examples of the state of the art. Such standards are periodically superseded by faster or more efficient equivalents having essentially the same functions. Accordingly, replacement standards and protocols having the same functions are considered equivalents.

The present disclosure relates to subject matter contained in priority Korean Application No. 2001-0026100, filed on May 14, 2001, which is herein expressly incorporated by reference in its entirety.

What is claimed is:

1. A method of upgrading an existing protocol of at least one networkable home appliance, comprising:
updating the existing protocol of the home appliance with a new version of the protocol and storing the updated new version of the protocol in a service provision server;
sending said new version of the protocol stored in the service provision server to a gateway connected to the home appliance, so as to download said new version of the protocol from the service provision server to the gateway; and
upgrading said existing protocol of the home appliance with said new version of the protocol downloaded to the gateway.

2. The method as set forth in claim 1, wherein sending said new version of the protocol stored in the service provision server to a gateway connected to the home appliance includes:
determining whether a user of the home appliance desires to download said new version of the protocol from the service provision server to the gateway; and
downloading said new version of the protocol from the service provision server to the gateway if it is determined that the user desires to download said new version of the protocol.

3. The method as set forth in claim 1, wherein said upgrading said existing protocol of the home appliance with said new version of the protocol downloaded to the gateway includes:
determining whether said existing protocol of the home appliance can be upgraded with said new version of the protocol; and
upgrading said existing protocol of the home appliance with said new version of the protocol if it is determined that said existing protocol of the home appliance can be upgraded with said new version of the protocol.

4. The method as set forth in claim 3, wherein said determining whether said existing protocol of the home appliance can be upgraded with said new version of the protocol includes comparing the size of an available area of a protocol storage memory of the home appliance with the data size of said new version of the protocol and, if the size of the available area of the protocol storage memory is greater than the data size of said new version of the protocol, determining that said existing protocol of the home appliance can be upgraded with said new version of the protocol.

5. The method as set forth in claim 1, wherein said upgrading said existing protocol of the home appliance with said new version of the protocol downloaded to the gateway includes:
allowing the home appliance to notify the gateway of an upgrade start address of a protocol storage memory thereof; and
writing said new version of the protocol into the protocol storage memory beginning with the upgrade start address.

6. The method as set forth in claim 5, wherein the upgrade start address of said protocol storage memory is spaced from a written address of said existing protocol with other addresses therebetween such that said existing protocol and said new version of the protocol are stored together in the protocol storage memory.

7. The method as set forth in claim 5, wherein upgrading said existing protocol of the home appliance with said new version of the protocol if it is determined that said existing protocol of the home appliance can be upgraded with said new version of the protocol includes:
sequentially writing a version name of said new version of the protocol, random data and confirmation data into the protocol storage memory beginning with the upgrade start address, the random data being randomly extracted from said new version of the protocol, the confirmation data having the same size as that of the random data; and
writing said new version of the protocol into the protocol storage memory beginning with an address subsequent to a written address of the confirmation data.

8. The method as set forth in claim 7, further comprising:
comparing the random data with the confirmation data after storing said new version of the protocol, to determine whether said new version of the protocol has been properly written.

9. A method of upgrading an existing protocol of at least one networkable home appliance, comprising:
providing at least one networkable home appliance, said at least one networkable home appliance including a flash memory having an existing protocol stored therein;
providing a gateway between said at least one networkable home appliance and a service provision server, providing connections between said at least one networkable home appliance and said gateway and between said gateway and the service provision server so that said networkable home appliance communicates with said service provision server through said gateway;
providing an updated new version of the protocol and storing said updated new version of the protocol in the service provision server;
sending said new version of the protocol stored in the service provision server through said connections to said gateway and downloading said new version of the protocol from the service provision server to said gateway; and
upgrading said existing protocol of the home appliance with said new version of the protocol downloaded to said gateway.

10. The method as set forth in claim 9, wherein said sending said new version of the protocol stored in the service provision server through said connections to said gateway connected to said home appliance includes:
determining whether a user of said home appliance desires to download said new version of the protocol from the service provision server to said gateway; and
downloading said new version of the protocol from the service provision server to said gateway if it is determined that the user desires to download said new version of the protocol.

11. The method as set forth in claim 9, wherein said upgrading said existing protocol of said home appliance with said new version of the protocol downloaded to said gateway includes:
determining whether said existing protocol of said home appliance can be upgraded with said new version of the protocol; and
upgrading said existing protocol of said home appliance with said new version of the protocol if it is determined that said existing protocol of said home appliance can be upgraded with said new version of the protocol.

12. The method as set forth in claim 11, wherein determining whether said existing protocol of said home appliance can be upgraded with said new version of the protocol includes comparing the size of an available area of a protocol storage memory of said home appliance with the data size of said new version of the protocol and, if the size of the available area of the protocol storage memory is greater than the data size of said new version of the protocol, determining that said existing protocol of said home appliance can be upgraded with said new version of the protocol.

13. The method as set forth in claim 9, wherein to upgrade said existing protocol of said home appliance with said new version of the protocol downloaded to said gateway;
said home appliance notifies said gateway through said connections of an upgrade start address of a protocol storage memory thereof; and
said gateway writes said new version of the protocol into the protocol storage memory beginning with the upgrade start address.

14. The method as set forth in claim 13, wherein the upgrade start address of said protocol storage memory is spaced from a written address of said existing protocol with other addresses therebetween such that said existing protocol and said new version of the protocol are stored together in the protocol storage memory.

15. The method as set forth in claim 13, wherein to upgrade said existing protocol of said home appliance with said new version of the protocol if it is determined that said existing protocol of said home appliance can be upgraded with said new version of the protocol;
said gateway sequentially writes a version name of said new version of the protocol, random data and confirmation data into the protocol storage memory beginning with the upgrade start address, the random data being randomly extracted from said new version of the protocol, the confirmation data having the same size as that of the random data; and
said gateway writes said new version of the protocol into the protocol storage memory beginning with an address subsequent to a written address of the confirmation data.

16. The method as set forth in claim 15, further comprising:
comparing the random data with the confirmation data after storing said new version of the protocol, to determine whether said new version of the protocol has been properly written.

17. A system for upgrading an existing protocol of at least one networkable home appliance, comprising:
at least one networkable home appliance; and
a gateway that provides communication between said networkable home appliance and a service provision server;
wherein the existing protocol of the home appliance is updated with a new version of the protocol and the updated new version of the protocol is stored in a service provision server;
said new version of the protocol stored in the service provision server is sent to said gateway connected to the home appliance, so as to download said new version of the protocol from the service provision server to said gateway; and
said existing protocol of the home appliance is upgraded with said new version of the protocol downloaded to said gateway.

18. The system for upgrading an existing protocol of at least one networkable home appliance as set forth in claim 17, wherein sending said new version of the protocol stored in the service provision server to said gateway connected to said home appliance includes:
determining whether a user of said home appliance desires to download said new version of the protocol from the service provision server to said gateway; and
downloading said new version of the protocol from the service provision server to said gateway if it is determined that the user desires to download said new version of the protocol.

19. The system for upgrading an existing protocol of at least one networkable home appliance as set forth in claim 17, wherein said upgrading said existing protocol of said home appliance with said new version of the protocol downloaded to said gateway includes:
determining whether said existing protocol of said home appliance can be upgraded with said new version of the protocol; and
upgrading said existing protocol of said home appliance with said new version of the protocol if it is determined that said existing protocol of said home appliance can be upgraded with said new version of the protocol.

20. The system for upgrading an existing protocol of at least one networkable home appliance as set forth in claim 19, wherein said determining whether said existing protocol of said home appliance can be upgraded with said new version of the protocol includes comparing the size of an available area of a protocol storage memory of said home appliance with the data size of said new version of the protocol and, if the size of the available area of the protocol storage memory is greater than the data size of said new version of the protocol, determining that said existing protocol of the home appliance can be upgraded with said new version of the protocol.
